(19) United States
(12) Patent Application Publication
(10) Pub. No.: US 2003/0187949 A1
(43) Pub. Date: Oct. 2, 2003

(54) Determining geographic location of internet users

(76) Inventors: Jaydutt B. Bhatt, Lisle, IL (US); Kumar V. Vemuri, Naperville, IL (US)

Correspondence Address: Charles L. Warren, 28W525 Diversey Avenue, West Chicago, IL, 60185, US

(21) Appl. No.: 10/109,334

(22) Filed: Mar. 28, 2002

(51) Int. Cl. G06F 15/16

(52) U.S. Cl. 709/218; 379/142.01; 709/227

(57) ABSTRACT

The geographic location of an Internet user is determined and correlated with the Internet protocol address of the user during an active Internet session. This information is stored preferably by the user's Internet service provider so that Internet services can be provided to the user based on the user's location. The user's location can supplement a request for services made by the user so that the responding web site or application will have additional information on which to base a reply. Alternatively, a web site or application may initially seek to send messages and/or information to users within a predetermined geographical location.

### BACKGROUND

This invention relates generally to determining the location of users of Internet communication services so that services based on the user's location can be provided.

Techniques exist for determining the geographic location of users communicating using a conventional telephone. The location of users, especially in situations in which the user may not be able to accurately describe or give their location, is critical for emergency operations such as a “911” call placed in the United States. For example, the location of a caller can be determined by querying a database based on the telephone number of the caller. Such a database may contain the street address, city, state, and ZIP code organized in records according to telephone number. A central office switch or private branch exchange can receive and store the automatic number identification (ANI) transmitted by the originating switch which typically w contains the telephone numbers of the calling party and the called party. Thus, with knowledge of the calling party's telephone number, the location of the caller can be determined from a database that stores locations associated with telephone numbers.

Different techniques exist for determining the geographic location of users communicating using wireless devices, such as a cellular telephone or a point-to-point walkie-talkie. It is well known to use triangulation techniques to locate the source of a radio frequency signal when a plurality of geographically separated receivers concurrently receive the signal. Navigational aids determine location such as by utilizing LORAN and GPS systems. A GPS receiver included as part of a communication device can provide an accurate location of the user by transmitting the GPS coordinate information to a site which relates the coordinates to a map of the relevant area.

It may be desirable to communicate with Internet users who are in a certain geographic area. For example, it would be convenient to be able to notify all active Internet users within a given geographic area of a weather emergency, e.g. a tornado warning. Other non-emergency situations may exist in which it is desirable to determine the location of an Internet user. A user may desire that his location be known to a Web site so that additional services can be provided that are location dependent, such as suggesting entertainment or restaurants available near the user.

Typically Internet users are assigned a dynamic Internet protocol (IP) address upon establishing a dial-up connection to the Internet service provider (ISP). Since the user's IP address varies, it cannot be mapped into a predetermined database that will always correlate with a given user. This complicates the problem of identifying a given user and the user's location. A relatively small Internet service provider operating in only a limited geographic region may be assigned a predefined range of IP addresses that can be assigned to its users. Therefore, a database could be established that would map all users assigned to IP addresses within this range to the geographic region served by the ISP. However, such a technique would not be suitable for an ISP that provides nationwide service since a user with an assigned IP address from such an ISP could be located anywhere within the large served region. Therefore, a need exists for an improved technique for determining the geographic location of an Internet user.

### SUMMARY OF THE INVENTION

It is an object of the present invention to provide an improved technique for determining the geographic location of Internet user.

In accordance with an embodiment of the present invention, a request for Internet service over a dial-up telephone connection is received. In response to a message transmitted from the Internet service provider, a cookie is generated and stored on the computer used by the user for Internet communications. The cookie contains the telephone number dialed by the user in seeking Internet service and the Internet protocol address of the user. Information stored in the cookie can be retrieved by an authorized server whereby the user can receive services based on location as derived from information contained in the cookie.

In accordance with a further embodiment of the present invention, the telephone call by the user seeking Internet services by a dial-up connection is terminated at a call terminating apparatus, e.g. a network access server. Automatic number identification information associated with the telephone call is received at the network access server. The automatic number identification information contains the telephone number from which the user placed the telephone call seeking Internet services. An Internet protocol address is assigned to the user. At least part of the received automatic number identification information is stored along with the assigned Internet protocol address to form a record from which the geographic location of the user can be derived.

According to another embodiment of the present invention, a telephone call by a user seeking Internet services is terminated at a call terminating apparatus, e.g. a network access server. A radio frequency communication link is traversed as part of the Internet service path. An Internet protocol address is assigned to the user. Geographic location information about the user is based on information determined by infrastructure supporting the radio frequency communication link and is received at the network access server. The geographic location information and the assigned Internet protocol address are stored to form a record from which the geographic location of the user can be retrieved.

### BRIEF DESCRIPTION OF THE DRAWINGS

FIG. 1 shows a portion of a network that supports one embodiment of a method according to the present invention.

FIG. 2 shows a portion of a network that supports another embodiment of a method according to the present invention.

FIG. 3 shows a portion of a network that supports a further embodiment of the method according to the present invention.

FIG. 4 shows a portion of a network including a wireless communication link that supports an embodiment of a method according to the present invention.

### DESCRIPTION OF EMBODIMENTS

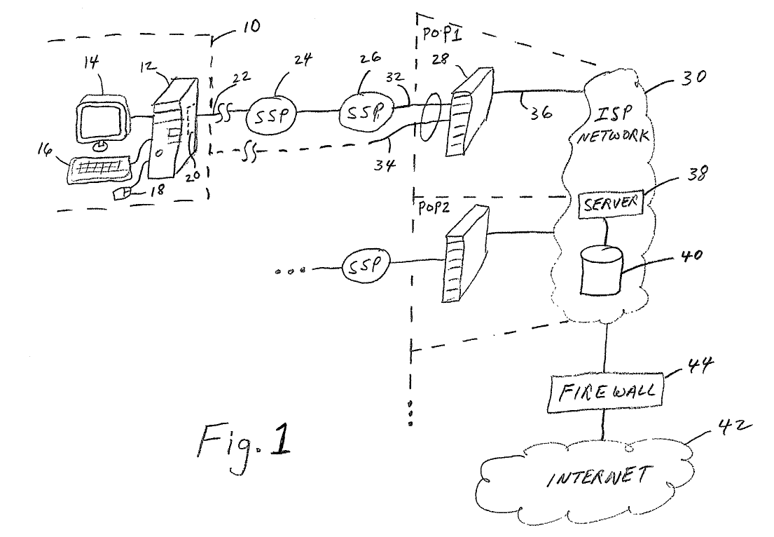

Referring to FIG. 1, a user's Internet communication apparatus 10 includes a computer 12 coupled to a monitor 14, the keyboard 16, and a mouse 18. The computer 12 includes a modem 20 for communicating over a telecommunication line 22, which may consist of a conventional analog dial-up telephone line in the public switched telephone network. Communication apparatus 10 is merely exemplary of a variety of communications equipment that can be used to access the Internet, such as a laptop computer, a personal digital assistant, etc. In this illustrative example, the user obtains Internet service by placing a telephone call which is routed by service switching points (SSP) 24 and 26 to call terminating apparatus 28, e.g. network access server (NAS), which is connected to Internet service provider network 30 from which the user obtains Internet service.

For purposes of clarity only a portion of the telecommunication network is shown that would be utilized to support a dial-up call from the user's communication apparatus 10 that terminates at the network access server 28. For example, an originating telephone central office would provide telephone services to the user by telephone line 22 and would be responsible for initially requesting the establishment of a call path to the dialed number that in this case is the network access server 28 associated with ISP 30. A conventional pool of modems (not shown) is associated with the network access server 28 and used to establish data communications with modem 20 of computer 12 over the established communication path. As will be known to those skilled in the art, the public switched telephone network traditionally employs a command and control signaling network, such as SS7, used to pass messages and signals associated with the setting up and tearing down of a telephone call. In the illustrative example, SSP 24 and 26 as well as communication channel 32 comprise part of the signaling network. An associated communication channel 34 set up under the control of the signaling network provides a communication path between the user and network access server 28; in this example, the communication path will carry modem signals between modem 20 in computer 12 and a modem in the NAS associated modem pool to establish a data communication path to the user for Internet access.

ISP network 30 is connected to network access server 28 via broadband communication channel or trunk line 36 that is capable of carrying a plurality of concurrent subscriber communication channels. The ISP network 30 includes a server 38 that is coupled to a database 40. The server 38 serves as the interface between subscribers and Internet 42 that is connected by firewall 44 to ISP network 30. The database 40 stores records associated with the subscribers. In this illustrative example, ISP network 30 includes a plurality of points of presence (POP) of which POP 1 and POP 2 are shown. Each point of presence includes a network access server that supports a plurality of subscribers of the ISP, and each point of presence typically has an associated group of telephone numbers by which subscribers obtain access. Each of the points of presence is configured and operates similarly to POP 1.

In accordance with an embodiment of a method of the present invention that can be practiced by the structure shown in FIG. 1, ISP 30 such as by server 38 causes a cookie to be generated on the user's computer 12. The cookie preferably contains the telephone number dialed by the user in establishing Internet access and the Internet protocol address used for the communication session. Alternatively, the cookie can be generated and stored on the user's computer by the software dialer used to initially access the ISP. Typically, ISP 30 will dynamically assign an Internet protocol address to the user upon the user successfully accessing and logging in to the ISP. The cookie is configured so that it can be accessed by an authorized Internet server or web site, such as server 38. The location of the user can be determined based upon the telephone number dialed to gain access to the ISP as obtained by reading this information from the cookie stored in the user's computer by the authorized server. This method relies on the proximity of the user being tied to the dialed telephone number. For example, in a typical situation a dial-up Internet access user will select a telephone number of a central office that is a local call for the user so that the user does not have to pay telephone access charges based on the length of time of the call. Thus, assuming a local call has been dialed, the location of the user will typically be within a local calling area associated with a telephone central office, e.g. a radius of approximately 8 miles is a typical local calling area as defined by local exchange carriers in the United States. Database 40 may contain geographic area information for each telephone number supported by the points of presence of ISP 30. Thus, server 38 can determine the geographic location of the user by retrieving the geographic location from database 40 based on the telephone number read from the cookie. Also since the Internet protocol address of the user is known from reading the stored cookie, services, e.g. messages and Web based information, can be provided to the user based upon the geographic location of the user.

The above described technique of locating an Internet user relies on the telephone number dialed by the user to gain Internet access. If the user does not dial a “local” telephone number, then the above-described technique will not yield the desired location information. A modification of the above-described technique may provide an improvement in location accuracy. In accordance with a further enhancement of the above-described embodiment, the user is requested to enter the telephone number from which the call is being placed. The user's telephone number is then stored, preferably along with the telephone number to be called and the user's Internet protocol address, in the cookie. Now when an authorized server reads the information contained in the cookie, the telephone number from which the user placed the call is determined. Alternatively, the user could manually place a telephone number in the cookie where that number is better associated the location desired by the user for location services information. With this information, the authorized server, such as server 38, can obtain geographic information correlated to the user's telephone number. The geographic information can be stored in database 40, or can be obtained from a database such as contained in the public switched telephone network that correlates telephone numbers with a street address, city, and state. By relying on the user's telephone number, as opposed to the telephone number dialed by the user to gain Internet access, greater confidence in the accuracy of the geographic location of the user is achieved. This technique is advantageous in that it does not rely upon the assumption that the dialed telephone number to gain Internet access was a “local” telephone number for the user.

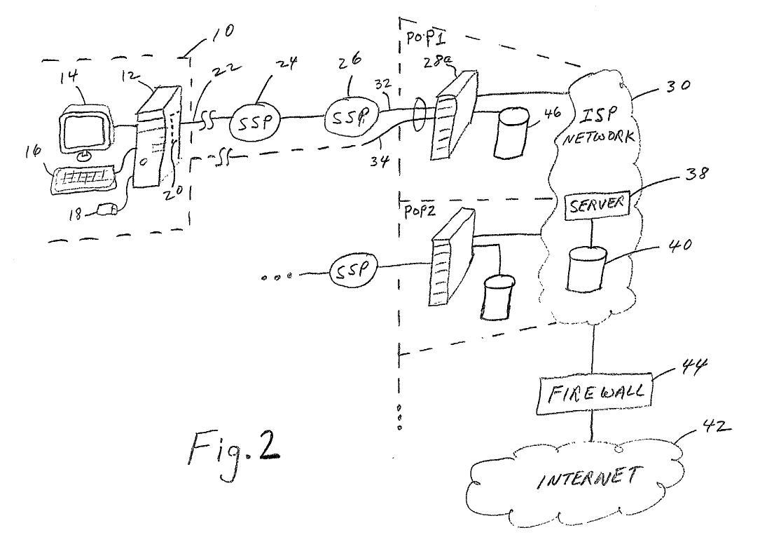

Referring to FIG. 2, an alternate embodiment of the method according to present invention will be described. Common reference numerals are used in different figures to denote the same elements. According to this embodiment at least a portion of the automatic number identification (ANI) associated with the call place by the user seeking Internet services is received and stored by the call terminating apparatus 28a, e.g. a network access server. This embodiment the network access server accepts and stores the ANI data in a manner similar to a terminating central office switch or private branch exchange. Typically, the user's originating telephone central office switch will generate the information to be contained within the ANI that includes the called party telephone number and the calling party's telephone number. The network access server 28a generates a record associated with the Internet session that can be stored on associated database 46, or alternatively in database 40. The record includes the Internet protocol address assigned to the user for the session and at least a portion of the ANI information, preferably the calling party's telephone number. This record is made accessible to an authorized server, such as server 38, or authorized Web sites in order to provide location specific services to the user. The database in which the record is stored may also contain geographic information indexed by telephone numbers. Alternatively, the calling party's telephone number can be utilized to query a different database that contains the geographic based information. Since the user's Internet protocol address is stored as part of the record, information can be conveyed to the user based upon the user's geographical location. For example, an advertising message could be broadcast to users within a predetermined geographic location, or a notice of emergency weather conditions such as a tornado warning could be sent to users within the warning area. Also, the user's geographical location can be used to supplement a query originated by the user for Web based services which may vary depending upon location, such as current movies now playing in nearby theaters or restaurants within a specified area or predetermined distance relative to the user. In this embodiment, the user's originating telephone number is automatically captured without requiring interaction with the user's computer 12, that is, a cookie is not required to be generated in order to obtain the information.

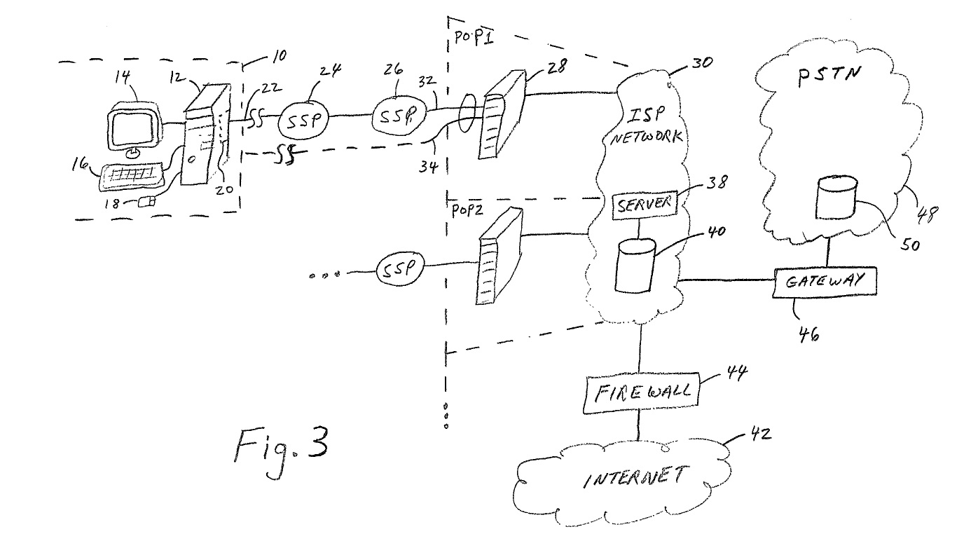

Referring to FIG. 3 a further embodiment of the method according to the present invention will be described. In this embodiment each point of presence established by ISP 30 contains at least one network access server to which is assigned a predetermined range of Internet protocol addresses. For example, access server 38 will store in database 40 a predetermined series of Internet protocol addresses for each network access server. Even though dynamic assignment is made to users of an Internet protocol address, the assigned Internet protocol address will be limited to be within the predefined address grouping assigned to the network access server that receives the user's call seeking Internet service. By assigning only a limited number of telephone numbers by central office code to each point of presence, it is likely that users within a predetermined geographic area will utilize only points of presence where the call for Internet service will be a “local” call. By using this technique the geographic location of a user can be assumed to be within an area associated with each point of presence. Users associated with each point of presence can be easily determined based upon the Internet protocol address assigned. Thus, the Internet protocol address assigned to the user will also have a predetermined geographic significance.

Gateway server 46connects ISP 30 with the public switched telephone network 48 and to database 50 that stores geographic based data corresponding to telephone numbers. In order to provide geographic location information about a user in response to a request from Internet 42 to ISP 30, server 38 can initiate a query of database 50 based on telephone office code's associated with the network access server providing service to the user, assuming that the network access server is a local telephone number relative to the user. Upon receiving a reply from database 50, server 38 can then determine based on active user Internet protocol address information stored in database 40 which users are within the geographic area defined by the query received from the Internet 42. This permits location-based services to be provided to a user.

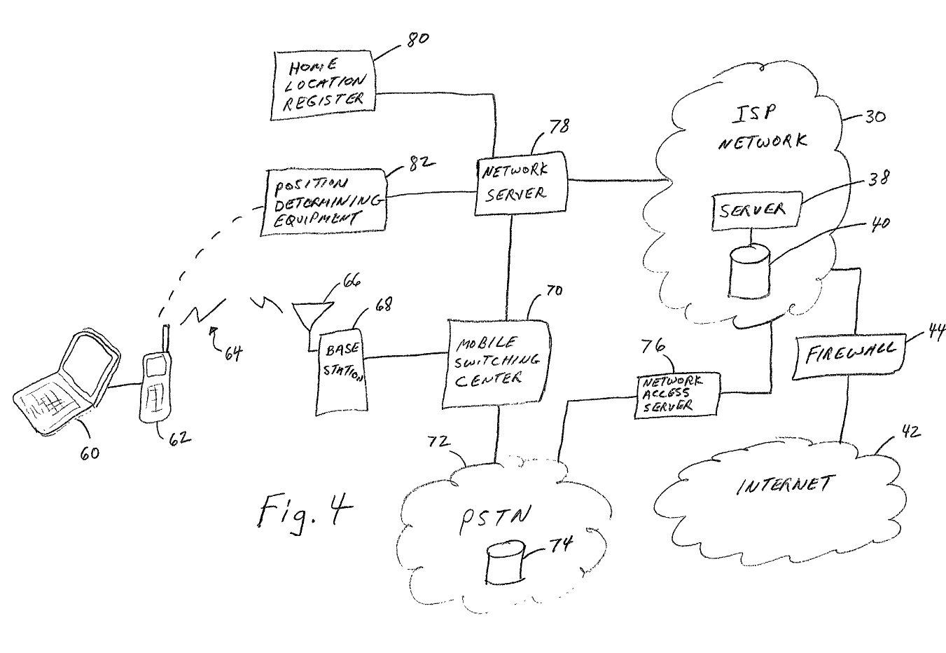

FIG. 4 illustrates a wireless environment that supports an embodiment of a method according to the present invention. In this embodiment a user seeks Internet access over a wireless transmission link, such as a cellular telephone channel, etc. The geographical location of the user is determined by wireless infrastructure and stored by the ISP network in order to provide Internet based services for the user based on the user's location.

A communication terminal 60, such as a laptop computer, personal digital assistant, etc., is coupled to a portable wireless transceiver 62 which may comprise a cellular telephone or other wireless device. A wireless channel 64 couples device 62 to wireless base station 68 by antenna 66. The base station 68 serves as an interface between radio frequency signals transmitted to and received from device 62, and digital signals carried over a communication link to mobile switching center 70. The communication channels served by the mobile switching center 70 are coupled to the public switched telephone network 72 that contains a database 74. Access to the ISP network 30 from the public switched telephone network 72 is provided by network access server 76 which can terminate calls from users seeking Internet access.

The mobile switching center 70 is also coupled to network server 78 which may comprise a gateway mobile location server in the EMEA system, or a mobile positioning center in the NAR system. The network server 78 is also coupled to home location register 80, position determining equipment 82 and the ISP network 30. The home location register 80 serves its conventional purpose of providing identification and validation of wireless subscribers. The position determining equipment 82 may consist of a location determining apparatus that implements an algorithm that ascertains the geographic location of wireless device 62. The geographic location of the wireless device 62 is determined by the position determining equipment 82 and forwarded by network server 78 to ISP network 30. At the beginning of the Internet session the ISP 30 receives and stores the telephone number of wireless device 62 such as by using a previously described method. And of course the ISP knows the IP address being used by terminal 60 for the current Internet session. The ISP 30 sends a query based on the telephone number of device 62 to network server 78 requesting geographic location information about device 62. This location information is obtained from position determining equipment 82 and sent to the ISP 30. Thus, the ISP 30 can maintain a record containing the user's telephone number, IP address, and geographic location information.

The ISP network 30 stores and maintains updated geographic information together with the Internet protocol address, and preferably the user's telephone number, for each active wireless user that subscribes to the ISP. For each active wireless user, database 40 stores a record containing at least the user's Internet protocol address assigned for the session and the user's geographic location as provided to ISP network 30 through network server 78. This permits Internet services to be provided to the user based on the geographic location of the user. Preferably, the position determining equipment 82 provides periodic updates concerning the location of terminal 60 that is relayed by network server 78 to ISP network 30 and server 38 to database 40 so that the records stored in database 40 for wireless users remain accurate throughout the Internet session. Alternatively, the ISP 30 can send queries to the network server 78 to seek updated location informtion, either periodically or prior to responding to a request for location information about the user, in order to support location accuracy during the IP session. Updates may be important for highly mobile users whose location changes significantly over the course of the IP session.

With regard to all of the above embodiments of the methods in accordance with the present invention, it will be apparent that privacy and security concerns exist. Security concerns can be addressed by encrypting records relating to the user, and especially records which could be more sensitive such as the geographical location of the user. Privacy relating to the users geographical location will vary depending upon the desires of the user. In some situations a user may desire any Web based application to have access to the user's geographical location in order to provide messages and/or services based on location. Other users in different situations may desire to restrict access to the geographical location information. Access to this information can be controlled and restricted by requiring authentication that the party or application seeking such access has been validated to receive this information, either on an individual basis as determined by each user or based on authentication of classes or categories of requesting parties. Privacy issues will also vary based on the granularity of the geographic location information sought. For example, a Web based weather report typically only needs zip code level location information whereas determining a nearby resturant requires more specific location information about the user. An ISP that controls the level of access to the users' location information may predetermine classes of privacy based on granularity of location needed and the preapproval of users for access by classes.

Although embodiments of the present invention have been described above and illustrated in the accompanying drawings, the scope of the invention is defined by the claims that follow. The specific embodiments are provided to illustrate examples of the present invention and are not to be interpreted as limiting the invention to only those specific steps or structure.

We claim:

1. A method for determining the geographic location of a user of Internet services comprising the steps of:
receiving at an Internet service provider a request from a user's terminal for Internet services over a dial-up telephone connection;
transmitting a message from the Internet service provider to the user's terminal to cause a cookie to be generated and stored on the terminal, the cookie containing the telephone number dialed by the user in seeking Internet services and the Internet protocol address of the user;
accessing information stored in the cookie by an authorized server, whereby the user can receive services based the location of the user as derived from information contained in the cookie.

2. The method according to claim 1 wherein the information stored in the cookie is received at the authorized server in response to the transmission by the authorized server to the user's terminal of a request for the information.

3. The method according to claim 1 further comprising the steps of sending an inquiry from the authorized server to a database seeking geographic data based on the information contained in the user's cookie, and receiving at the authorized server a reply to the inquiry containing the geographic data, whereby the geographic data can be utilized to provide services to the user based on the user's location.

4. The method according to claim 1 further comprising the steps of generating on the user's terminal a request that the user enter the current telephone number of the user, and upon the entry by the user of said current telephone number, storing said current telephone number as information contained within the cookie.

5. The method according to claim 4 further comprising the steps of sending an inquiry from the authorized server to a database seeking geographic data based on said current telephone number contained in the user's cookie, and receiving at the authorized server a reply to the inquiry containing the geographic data, whereby the geographic data can be utilized to provide services to the user based on the user's location.

6. A method for determining the geographic location of a user of Internet services comprising the steps of:
terminating at a call terminating apparatus a telephone call by the user seeking Internet services by a dial-up connection;
receiving, at the call terminating apparatus, automatic number identification (ANI) information associated with said telephone call, the ANI information containing the telephone number from which the user placed said telephone call;
assigning an Internet protocol address to the user;
storing at least part of the received ANI information and said assigned Internet protocol address to form a record from which the geographic location of the user can be derived.

7. The method according to claim 6 wherein said record includes the telephone number from which the user placed said telephone call.

8. The method according to claim 6 further comprising the step of querying a database utilizing information contained in said record to obtain geographic data about the location of the user.

9. The method according to claim 7 further comprising the step of querying a database utilizing the telephone number from which the user placed said telephone call contained in said record to obtain geographic data about the location of the user.

10. The method according to claim 6 wherein said storing step is carried out by storing said record in a database coupled to said call terminating apparatus.

11. The method according to claim 6 wherein said storing step is carried out by storing said record in a central database of an Internet service provider that provides Internet service to the user, the central database storing the records associated with users supported by the Internet service provider.

12. The method according to claim 6 further comprising the step of querying a database to obtain geographic data associated with the user derived from information contained in said record.

13. The method according to claim 12 wherein said query is transmitted to the database which is disposed in the public switched telephone network and contains geographic data based on telephone numbers.

14. The method according to claim 6 further comprising the step of receiving a query from an external network seeking to establish location information about a user based on a certain internet protocol address, and transmitting to said external network at least part of the record corresponding to the certain internet protocol address in response to the query.

15. The method according to claim 14 wherein said at least part of the record includes the telephone number from which the user placed said telephone call.

16. The method according to claim 6 further comprising the step of receiving a query from an external network seeking the current internet protocol address being used by a user based on a telephone number conveyed by the query, and transmitting to said external network at least part of the record corresponding to the telephone number conveyed in the query.

17. The method according to claim 16 wherein said at least part of the record includes the Internet protocol address associated with the telephone number conveyed by the query.

18. A method for determining the geographic location of a user of Internet services in which a radio frequency communication link is traversed in providing the Internet services comprising the steps of:
terminating at a call terminating apparatus a telephone call by the user seeking Internet services;
determining an Internet protocol address of the user;
receiving, at the call terminating apparatus, geographic location information about said user based on information determined by infrastructure supporting the radio frequency communication link;
storing the geographic location information and the user's Internet protocol address to form a record from which the geographic location of the user can be retrieved.

19. The method according to claim 18 further comprising the step of receiving a query from an external network seeking one of the geographic location information and Internet protocol address contained said record based on conveying the other of the geographic location information and Internet protocol address, and transmitting to said external network at least said one.

20. The method according to claim 18 further comprising the step of accepting radio frequency signals from a portable radio frequency communication device by which the user can travel to different locations while maintaining uninterrupted Internet services.
